(19) United States
(12) Patent Application Publication
(10) Pub. No.: US 2015/0242873 A9
(43) Pub. Date: Aug. 27, 2015

(54) INTERCONNECTING ENHANCED AND DIVERSIFIED COMMUNICATIONS WITH COMMERCIAL APPLICATIONS

(71) Applicants: Sanjay Patel, Surrey (GB); Richard Kewitz, Chicago, IL (US)

(72) Inventors: Sanjay Patel, Surrey (GB); Richard Kewitz, Chicago, IL (US)

(73) Assignee: iLyngo, LLC, Chicago, IL (US)

(21) Appl. No.: 14/039,185

(22) Filed: Sep. 27, 2013

Related U.S. Application Data
(63) Continuation of application No. PCT/US13/57777, filed on Sep. 3, 2013.
(60) Provisional application No. 61/697,253, filed on Sep. 5, 2012.

(51) Int. Cl. G06Q 30/02; G06Q 50/00; G06F 17/28

(52) U.S. Cl. CPC G06Q 30/0214; G06F 17/289; G06Q 50/01; G06Q 30/0226

(57) ABSTRACT

A system for interconnecting enhanced and diversified communications with commercial applications using efficient and user-friendly features and methods by which users can create, share, and proliferate symbols, use translations, message contractions, message expansions, hidden messages, scrolling or bill-boarding messages, timed messages, Morse messages, and inter-language translations, all using various forms of formatting and presentation configurations. Such system and communications are used and made amongst various social groupings, providing benefits and incentives for usage of the system, and personalized consumer insight that links to commercial applications

### RELATED APPLICATIONS

This application claims priority to PCT Patent Application Number PCT/US13/57777, titled “SYSTEMS AND METHODS FOR UTILIZING SYMBOLS IN THE CREATION AND TRANSMISSION OF COMMUNICATIONS”, filed Sep. 3, 2013, which claims priority from U.S. Provisional Patent Application No. 61/697,253 titled “SYSTEMS AND METHODS FOR UTILIZING SYMBOLS IN THE CREATION AND TRANSMISSION OF COMMUNICATIONS”, filed Sep. 5, 2012, the disclosures of both of which are incorporated herein by reference in its entirety.

### FIELD OF THE INVENTION

The present invention relates to efficient communications, and more particularly to connecting enhanced communications to commerce.

### BACKGROUND OF THE INVENTION

Despite the ubiquity of electronic communications, effective links between enhanced communications and the marketplace are non-existent. With regards to enhanced communications, the use of symbols, such as acronyms, pictures, or shorthand, to represent larger textual units (e.g., phrases or sentences) has grown with the proliferation of personal mobile communications devices and social networking. The limitations of these devices and services make it a necessity to transmit larger blocks of information by using abbreviated textual input. For instance SMS and Twitter® have limitations on the length of messages (e.g. 140-160 characters). Conveying context and semantics is difficult with such a restraint. Therefore, users create new languages, which are often referred to as “lingo” or “symbols” or “text-speak”, to convey information in a short form.

Accordingly, what are needed are efficient and user-friendly systems and methods by which users can create, share, and proliferate symbols, including translations, message contractions, message expansions, hidden messages, scrolling messages, timed messages, Morse messages, and inter-language translations, amongst various social groupings, providing benefits and incentives for usage of the system, and personalized consumer insight that links to commercial applications.

### SUMMARY OF THE INVENTION

The purpose and advantages of the below described illustrated embodiments will be set forth in and apparent from the description that follows. Additional advantages of the illustrated embodiments will be realized and attained by the devices, systems, and methods particularly pointed out in the written description and the claims herein, as well as from the drawings.

To achieve these and other advantages and in accordance with the purpose of the illustrated embodiments, described herein are systems and methods for connecting enhanced communications with the marketplace.

In one embodiment, users are provided a system for enhanced communications and receiving benefits, such as personalized rebates or discounts. Concurrently, a module processes the user's usage of the system and develops consumer insight into particular users. This information is then utilized to identify benefits that are customized for a specific user.

For example, if a user has medical needs that require prescription or over-the-counter products, the system may identify that the user may be interested in a coupon for reduced prices on the medication and/or reduced prices on other items purchased at the same time. The user may be given the option to purchase the discount/coupon in exchange for reward points that the user has accumulated, or the relevant retailer may simply gift the discount/coupon to the user. In another example, if a user is very involved in athletic activities, the system may identify that the user would be interested in free and/or cheaper athletic gear, such as basketball shoes.

A user may accrue reward points for any activities related to using the system. Such activities include, for exemplary purposes only and without limitation, opening the system, viewing message, contracting or expanding messages, selecting links and/or hidden content within messages, sending messages, receiving messages, inviting a member to use the system, high utilization of a module that practices the system, using and/or interacting with a website associated with the system, and/or sending debug reports if issues arise.

Additionally, the user may convert his/her reward points into other items of value, such as currency, legal tender, bit coins, or any other such item, either tangible or intangible, that have real or perceived value. Users may also trade or gift their reward points to other users.

In one embodiment, the system aggregates, manages and distributes symbols transparently between users and social or professional groups. Symbols may include text, audio, video, multi-media content, links to the same, or any communicable content. The system uses everyday common and new terms to improve on general communications and avoid misinterpretation. It aggregates new symbols on the fly used across all generations, professions and newer users so all can enjoy fuller device purpose, communication and enhanced experience. The system uses today's standard text-speak terms or symbols by default, but more importantly, also allows users to easily create new symbols via their normal use and typing of mobile messages. It also allows the user to create social and professional communities in order to share new symbols between such groups. The natural behavior to ‘create communities’ and ‘share with others’ has an inherent viral effect that make social networking a phenomena and success, which the system capitalizes upon effectively. Management and distribution of new symbols is automatic and transparent between users and associated groups.

Additional features allow users to translate text-speak to full native language and vice versa, either before sending the message or after receiving it. Benefits include shorter messages, faster transmissions, lower costs, and the bridging of any confusion, e.g., “[<18r @hm” can be translated to/from “Call you later at home”. Also, users can backup and restore their accumulated new symbols in order to maintain continued experience with their new mobile devices and applications.

The system is a Text, SMS slang, multi-media, Emoticon, Acronym and Abbreviation communications system. It allows users to communicate with such types of input styles including, but not limited to, full text, variant types of text/graphic shorthand, and/or variant types of text/graphic depiction etc. The system works with or can work with all other current and future text based Communication Systems including, but not limited to, SMS texting, Instant Messaging, Email, Facebook®, Twitter®, Chat Rooms, blogs, document authoring etc., as well as with all input mediums including, but not limited to, touchscreen, voice, keyboard/pad input, gesturing, handwriting, sign/text motioning, and predictive text/error correction systems etc.

Symbols are either commonly used (e.g., within SMS texting, Instant Messaging etc.), intrinsically prevalent (e.g., Acronyms and Abbreviations, e.g., within Military, Medical, Enterprise etc.), or are created on the fly specifically by individual users, groups or communities etc. as variant polarizations. Specifically created symbols can be normalized (i.e., cleaned and grouped) by a module which then enable such united symbols to be shared amongst subscribing users, groups or communities etc., respectively. Common language is the greater medium and enabler to a broader more meaningful and usable communications and means thereof. Thus connecting people by using the very nature by which they wish to communicate with, i.e., symbols by creating, sharing and using the system.

The system can also translate symbols to full text language(s), and vice versa, thus bridging any communication gaps particularly between generational families, enterprise departments or other market sectors, i.e., slang or other language styles etc. is made common and understandable throughout via the system.

The system is applicable to a multitude of languages, including, but not limited to, US English, UK English, Japanese, Italian, French, Spanish, German, Korean and Japanese. The system allows any user of any language orientation to create their naturalized symbols. Thus the accumulation, propagation, and constant proliferation of regionalized symbols are down to the user, group, and community actions, i.e., sharing and subscribing thereof. This allows the system to provide for all types of symbols for all languages, and nurtures users, groups, communities and regions to create their own shared symbols.

In one embodiment, the systems initiate a first message on a cell phone and subsequently access, via a translation engine, a dictionary. The system identifies, via the translation engine, a first string of character in the first message, and compares the first string of characters to at least one set of associated entries in the dictionary. The system translates, via the translation engine accessing the dictionary, the first message into a second message, the translation including contracting or expanding the first message or adding/altering content such as multi-media content. The second message is then displayed on the computing device's display.

Concurrently, in one embodiment, the system analyzes the user's interests and preferences and identifies consumer insight that is particularized to each user.

The system may also identify a set of associated entries in the database, with the first entry in the identified set being identical to the first string of characters. For example, the first entry in the identified set may include both letters and numbers, and the second entry in the identified set may include only letters.

The system may create and use several different types of dictionaries for each user. For example, each user may have access to a standard dictionary that has typical symbol conversions, e.g., “cul8r”=“see you later.” Each user may also have access to a user-specific dictionary that includes symbol associations that have been identified, either explicitly or implicitly, by the user. Explicit identification of symbols may include, for exemplary purposes only, selecting a highlighted section of text and identifying either a contraction or an expansion of the text, capitalizing the first letter of each word in a phrase (e.g., Estimated Time of Arrival=“ETA”), or type brackets to identify a preferred translation (e.g., “Estimated Time of Arrival [ETA]” or “ETA [Estimated Time of Arrival]”).

Further, the system can be used to translate between symbols and natural communication for a single language, between different languages, or combinations thereof (e.g., natural communication of a first language to/from symbols of a second language).

The system may also detect a swiping motion on the display, such as on a smart phone, that instructs the translation engine to either contract or expand the first message. The swipe may be generally diagonal relative to the display's (current) viewing orientation, or it may be in any direction, or the instruction to contract/expand may be given via any means as known in the art (e.g., key press, motion of the device).

The system may also detect a selection of the first string of characters, display a list of translation options for the first string of characters, and detect a selection of one translation option from the list of translation options. The system may also detect the entry of a translation for a selected string of characters, and subsequently store the newly-defined translation as a new set in the second dictionary, with the new set including the selected first string of characters and the selected translation option. The new set may be communicated from a client device, such as a smart phone, to a server module. The translation may include shortening or lengthening the length of the message.

### BRIEF DESCRIPTION OF THE DRAWINGS

So that those having ordinary skill in the art, to which the present embodiments pertain, will more readily understand how to employ the novel system and methods, certain illustrated embodiments thereof will be described in detail herein-below with reference to the drawings, wherein:

FIG. 1A illustrates a system diagram of an exemplary embodiment of a system for interconnecting enhanced communications with personalized marketing;

FIG. 1B is a flow chart illustrating exemplary processes of utilizing the embodiment of FIG. 1A;

FIGS. 2-5 are exemplary screen illustrations practicing the embodiment of FIG. 1A;

FIGS. 6-8 are flow charts illustrating exemplary processes of utilizing the embodiment of FIG. 1A; and

FIG. 9 is an illustration of an embodiment of a computing device.

### DETAILED DESCRIPTION OF CERTAIN EMBODIMENTS

The below illustrated embodiments are directed to management system and method for interconnecting enhanced communications and personalized marketing in which a component or a feature that is common to more than one illustration is indicated with a common reference. It is to be appreciated the below illustrated embodiments are not limited in any way to what is shown, as the illustrated embodiments described below are merely exemplary of the invention, which can be embodied in various forms, as appreciated by one skilled in the art. Therefore, it is to be understood that any structural and functional details disclosed herein are not to be interpreted as limiting, but merely as a basis for the claims and as a representative for teaching one skilled in the art to variously employ the certain illustrated embodiments. Also, the flow charts described herein do not imply a required order to the steps, and the illustrated embodiments and processes may be implemented in any order that is practicable.

Unless defined otherwise, all technical and scientific terms used herein have the same meaning as commonly understood by one of ordinary skill in the art relating to the below illustrated embodiments. Although any methods and materials similar or equivalent to those described herein can also be used in the practice or testing of the below illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the certain embodiments described herein may be utilized in conjunction with a software algorithm, program or code residing on computer useable medium having control logic for enabling execution on a machine having a computer processor. The machine typically includes memory storage configured to provide output from execution of the computer algorithm or program. As used herein, the term “software” is meant to be synonymous with any code or program that can be executed by a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the certain embodiments described herein. Thus the certain embodiments are not to be understood to be limited by what has been particularly shown and described, except as indicated by the appended claims.

The methods described herein allow users to, in an exemplary use, utilize symbols and other content types in the creation and transmission of communications. A user may enter a message into a client device, such as a cell phone. A translation engine analyzes the message to identify content that may either be expanded or contracted. In one embodiment, the analysis is conducted in real-time as the message is being entered.

For example, if the user enters “cul8r”, the translation engine may identify those five characters as a candidate for expansion. If the user instructs the translation engine to expand the message, those five characters may be expanded to “see you later”, and such would be displayed on the client device's display. The counter-example is, if the user types “see you later”, the translation engine may identify those 13 characters as a candidate for contraction.

Possible candidates for contraction or expansion may be identified in the display in such ways as underlining each identified candidate. A user may then select an individual candidate and the translation engine may either immediately translate the content, it may display various candidates for translation (e.g., “lol” may mean “laugh out loud” or “lots of love”), or it may display an interface to define a new translation to be entered by the user, and these options may be performed simultaneously (e.g., multiple translations may be displayed even as the translation engine provides an interface to define a new translation).

After the user sends the message, the message may have fewer characters if the message was contracted. In one embodiment, the translation engine sends contracted messages to reduce the number of characters sent, and thus circumvent message limitations (e.g., 140 characters or 160 characters).

In one embodiment, the contracted message is displayed at a second user device as contracted, and the second user may expand the message by swiping the display and/or pressing a key. In another embodiment, the message is displayed at a second user device as expanded, and the second user may contract the message.

As new translations are defined, the client device may communicate the translations to the server module. The server module may use the field-generated translations and analyze them for correlations. For example, people from a certain geography may use a certain translation frequently, and so the server module may define a dictionary, such as a community dictionary, to include that translation. The subset-specific dictionaries may include group-specific dictionaries (e.g., students), community-specific dictionaries (e.g., Chicago, Ill.), and field-specific dictionaries (e.g., lawyers). Additionally, the client device may utilize a contact dictionary to translate between acronyms and/or shorthand to contacts listed in the contacts database, the contacts database include a local database on the client device and including a remote database that may be stored with the cell phone's service provider.

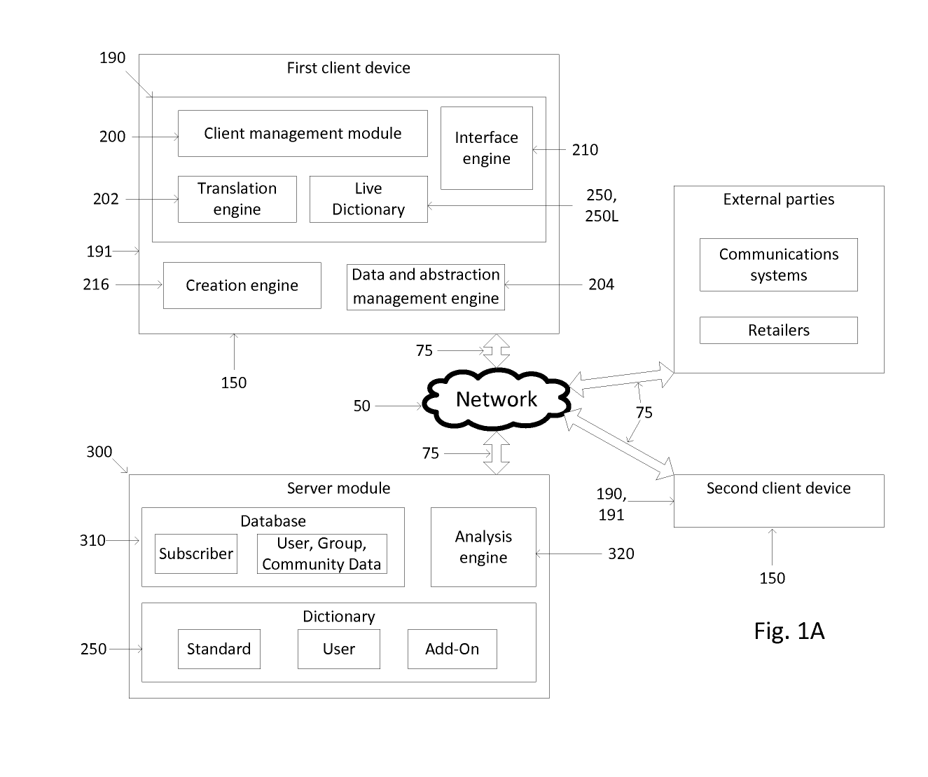

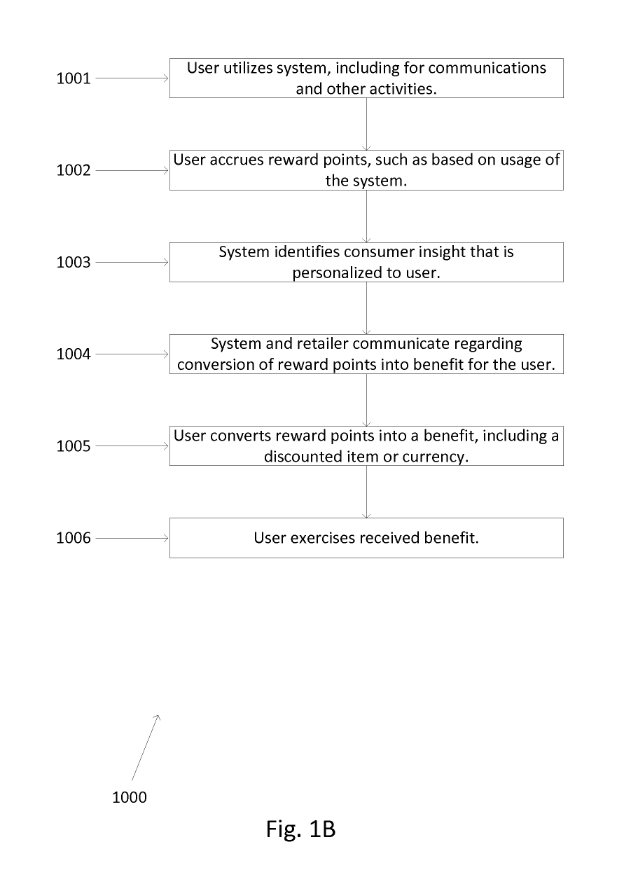

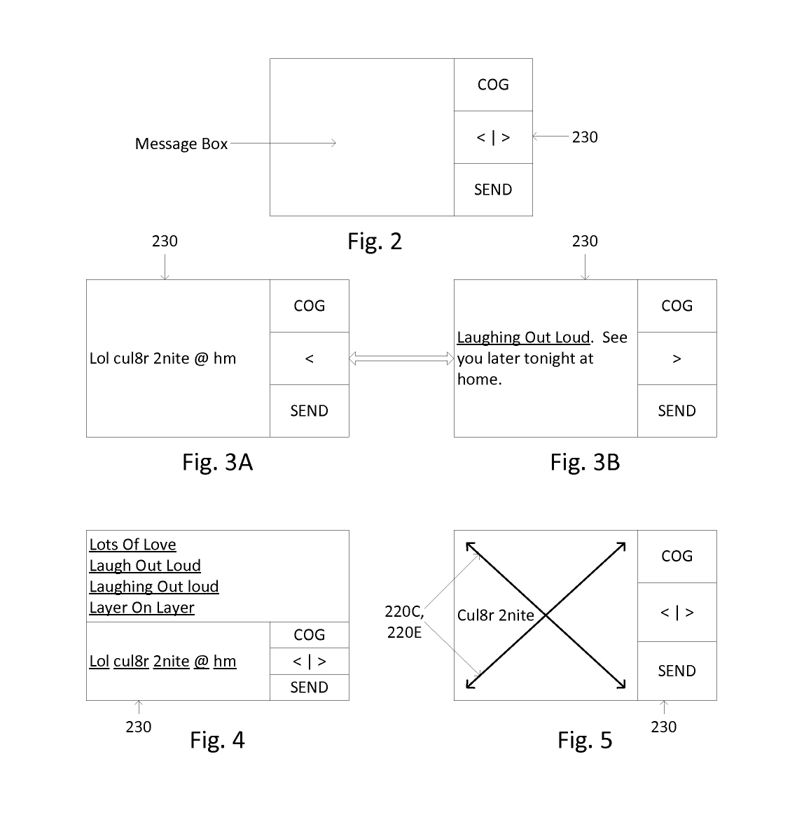

Referring to FIG. 1A, the hardware diagram depicts a system 100 in which the processes described herein may be executed is provided for exemplary purposes. In one embodiment, system 100 includes network 50, communications 75, devices 150, lite module 190, full module 191, client management module 200, translation engine 202, data and abstraction management engine 204, interface engine 210, creation engine 216, server 300, database 310, analysis engine 320, dictionary 250, including live dictionary 250L, and client device interface 230.

Turning now to FIG. 1B, illustrated therein is an exemplary process (1000) of utilizing system 100. Starting at step 1001, a user initiates utilizes the system. Such usage includes communications with other users, creation of symbols, usage of symbols, sharing of symbols, accrual and usage of reward points, and other uses as described herein. In one embodiment client management module 200 utilized by the user is practiced by full module 191, and is executed on a client device, such as a smart phone. During utilizing of client management module 200, the user may accrue reward points.

A user may accrue reward points (step 1002) for any activities related to using the system. For example, such activities include, for exemplary purposes only and without limitation, opening the program, viewing message, contracting or expanding messages, selecting links and/or hidden content within messages, sending messages, receiving messages, inviting a member to use the system, high utilization of a module that practices the system, using and/or interacting with a website associated with the system, and/or sending debug reports if issues arise. It is contemplated herein that the user may accrue reward points for any activity, and the activity may or may not be related to the system.

The user may opt-in to a program, whereby analysis engine 320 of server module 300 analyzes (step 1003) approved content by the user by such mechanisms as natural or heuristic language processing, such as analysis of symbols.

In one embodiment, an administrator of server module 300 may engage in communications with external parties (step 1004), such as retailers, regarding mechanisms for the users to benefit from their reward points. Retailers broadly includes any entity, either corporate or personal, that may provide goods or services, either for-cost or for free, including, for exemplary purposes only and without limitation, manufacturers (e.g., computer manufacturers), content providers (e.g., iTunes® and HBO®), resellers (e.g., Best Buy®), or any such business or concern. The communications between the administrator and external parties may include information gleaned by analysis engine 320 as to consumer insight regarding a particular user's preferences for goods and/or services. It is contemplated herein that the information developed by analysis engine 320 may be exchanged with another party. It is further contemplated herein that a user may explicitly identify preferred types of benefits (e.g., a user may identify plane tickets to a Hawaii as a desired item). The benefit may include the good/service being free for the user, the good/service having a reduced price (in terms of currency) for the user, or the user may redeem reward points in exchange for a price reduction (including an entire price reduction, i.e., the good/service is free).

The user may convert their reward points into a benefit, such as a coupon for goods/services (step 1005). This conversion may include the user redeeming accrued reward points in exchange a reduction in the price of the good or service. Finally, the user receives the benefit (step 1006).

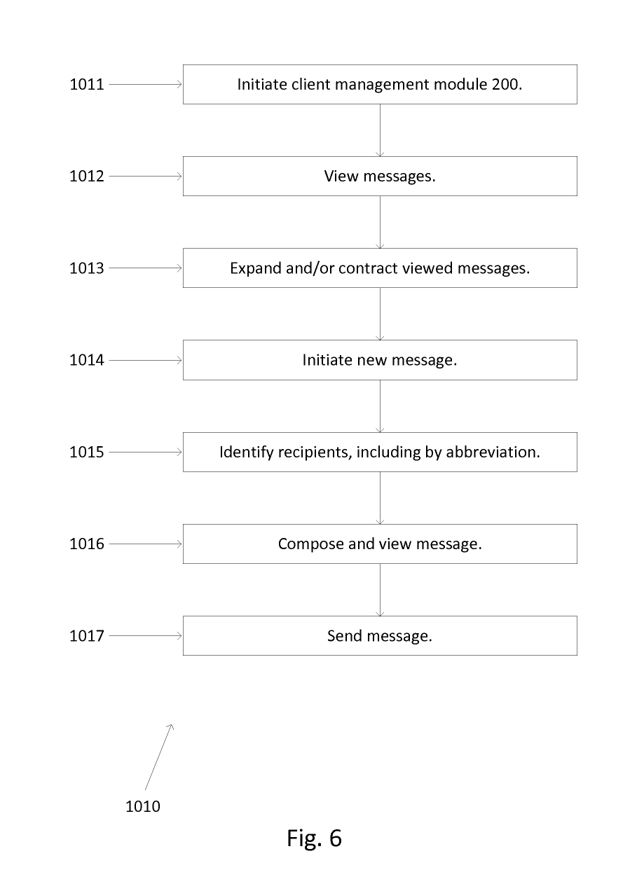

Turning to FIG. 6, in one embodiment, after client initiates client management module (step 1011), messages and message histories (step 1012) are displayed on client device interface 230 (e.g., a smart phone screen), and the user may expand and/or contract viewed messages (step 1013) via translation engine 202. The user initiates a new message (step 1014), and identifies at least one recipient. In one embodiment, recipients may be identified by typing in abbreviations and translation engine 202 will identify recipients by accessing dictionary 250, such as live dictionary 250L, and replacing the entered text with the name and/or contact information of the recipient. For example, if the user identifies a recipient of “SP”, translation engine 202 may identify that a contact named Sanjay Patel is the intended recipient, and accordingly replace “SP” with Sanjay Patel's name and/or contact information. In another example, the user may enter text that is converted to another content type, such as multi-media content. The user subsequently composes and view the message (step 1016), and sends the message (step 1017) to second client device 150. In one embodiment dictionaries 250 comprise a plurality of sets of translations, each set having at least a first and second entry that each define a translation term that may be translated from or to.

In one embodiment, system 100 provides diversified communications to users. It is contemplated herein that users may send text messages to one another, multi-media content, blurts (e.g., scrolling messages and/or visual effects), hidden messages, Morse code, timed messages, or any combination thereof.

Morse code communications may include the sending user dictating a message in Morse code (either by typing or via audio), or the user may send a normal message and a user may specify how the message is transmitted or received. For example, the message may be translated to Morse code and the senders or recipient's device vibrates the Morse Code, it may flash the Morse Code, it may emit sounds consistent with the Morse Code, or any other means of communication as known in the art.

Further, in one embodiment, system 100 may compact symbols, such as converting “see you later” to “cul8r” to “c8r.” It will be recognized that any symbol may be compacted into even shorter symbols, such as just demonstrated.

In another embodiment, system 100 translates between languages. For example, a user may type a symbol-filled message in English, and system 100 translates that message to full-text Japanese, symbol-filled Japanese, or a combination thereof.

It is further contemplated that the translation to/from symbols may include translating different types of content of communications into other content type. For example, the message “drum rim shot” may be translated into an audio message for the recipient that includes the generally recognizable “ba-dum . . . ching” (i.e., two quick hits on a snare drum, followed by a pause, then a light tap on a cymbal). However, it is recognized herein that any content type may be changed to any other content type, including transitions between text, symbols, audio, video, physical shaking of the recipient device, or other output as known in the art.

Further, it is contemplated herein that the user may identify any content that will be translated to/from. For example, “jerk” may be translated to “mean person”, or vice versa. For another example, the emoticon “;-)” may be translated to “just kidding”, or vice versa.

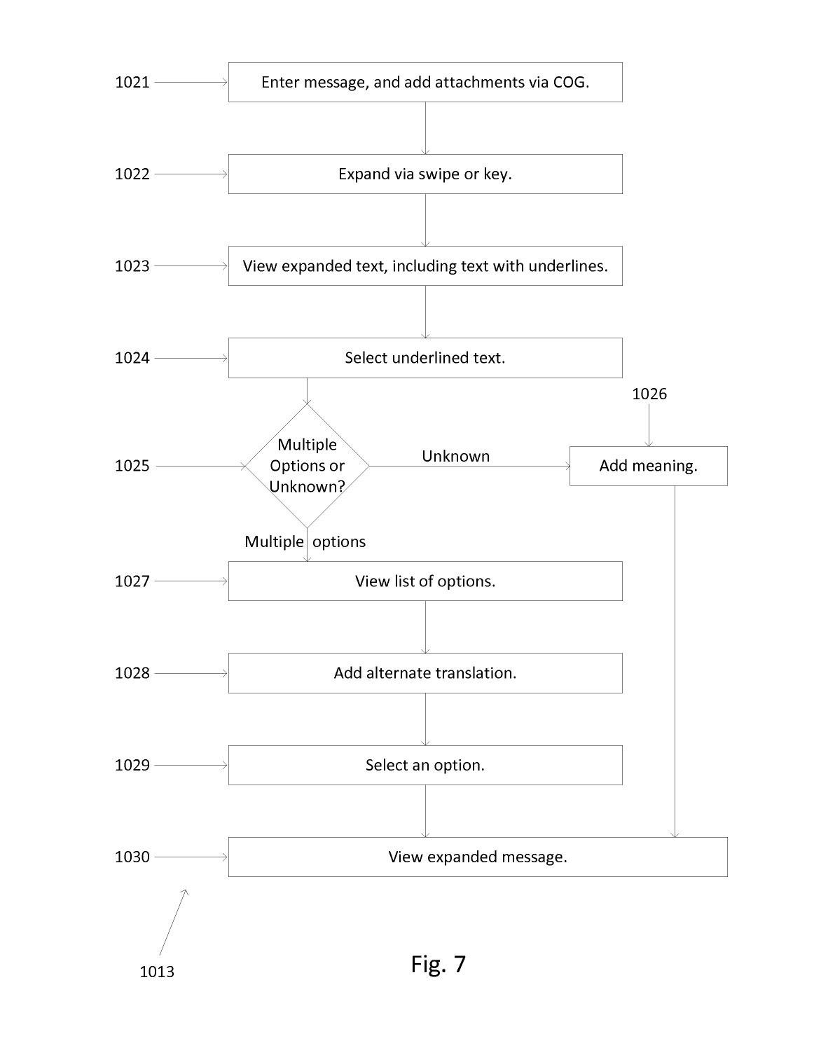

Turning to FIG. 7, illustrated therein is an exemplary process (1013) of expanding a message in accordance with step 1013 of the embodiment illustrated in FIG. 6. Starting at step 1021, the user may enter the message and add attachments to the message. In one embodiment, the user may enter symbols or short-hand characters that communicate information (best shown in FIG. 3A), or the user may enter a mostly grammatically-correct text, (sometimes referred to herein as “full-text”, and best shown in FIG. 3B). Within FIG. 6, and for exemplary purposes only, the user entered the message shown in FIG. 3A, and via step 1022 the user instructed translation engine 202 to expand the message.

In one embodiment, the display has a current orientation and the user instructs expansion by swiping client device interface 230 horizontally from either right-to-left or left-to-right, or diagonally from either bottom-left to top-right or bottom-right to top-left (best shown in FIG. 5). However, it is contemplated herein that any swiping motion may instruct an expansion of the message. In another embodiment, the user expands the message by hitting a key labeled “<” on client device interface 230. However, it is contemplated herein that any key and/or interaction may instruct an expansion.

While the user enters text, translation engine 202 may identify either a symbol or full-text that may be either expanded or contracted. In one embodiment, translation engine 202 will display the identified text via highlighting or underlines shown via client device interface (step 1023, and best shown in FIGS. 3B and 4). The user may select a unit of highlighted or underlined text (step 1024), and translation engine 202 will identify translation options (step 1025). In one embodiment, translation options include a single translation (e.g., “cul8r” may mean “see you later”), multiple translations (e.g., “lol” may mean “lots of love” or “laugh out loud”), or no known translation.

If there are no known translations, the user may enter an associated translation term (step 1026) that may be stored in dictionary 250. The new term may be created via creation engine 216, and data and abstraction management engine 204 may communicate the new term to server module 300, which may incorporate the new term into other dictionaries.

If there are multiple translations, the user may be presented a list of options to select from (step 1027, and best shown in FIG. 4). For exemplary purposes, and turning to FIG. 4, if the user selected “Lol” displayed therein, translation engine 202 may produce and display a list of options for the user to select from; in FIG. 4 those options are “Lots of Love”, “Laugh Out Loud”, “Laughing Out loud”, and “Layer on Layer”. The user may add an alternate translation (step 1028), and the new translation may be communicated to server module 300. Subsequently the user may select one of the options presented (step 1029), and then the user may view the expanded message (step 1030).

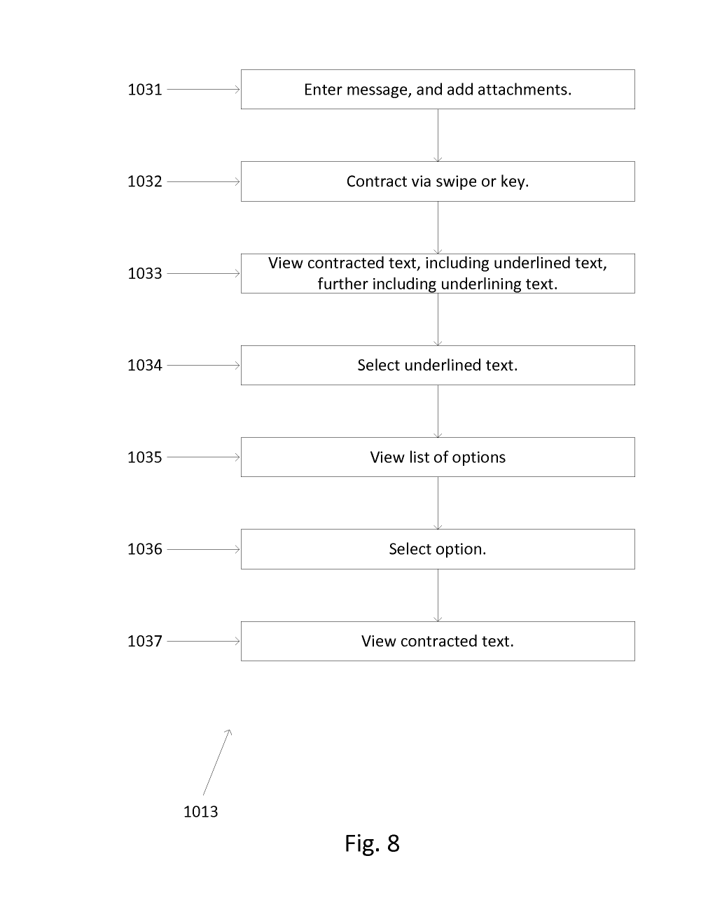

Turning to FIG. 8, illustrated therein is an exemplary process (1013) of contracting a message in accordance with step 1013 of the embodiment illustrated in FIG. 6. Via step 1032, the user instructs translation engine 202 to contract the message. In one embodiment the user instructs contraction by swiping client device interface 230 horizontally from either right-to-left or left-to-right, or diagonally from either top-left to bottom-right or top-right to bottom-left (best shown in FIG. 5). However, it is contemplated herein that any swiping motion may instruct a contraction of the message. In another embodiment, the user contracts the message by hitting a key labeled “>” on client device interface 230. However, it is contemplated herein that any key and/or interaction may instruct a contraction.

The user may select full-text (step 1034) that translation engine 202 identified as having translation options. The translation options may include no known translation or a list of possible translations (step 1035), and subsequently the user may select one of the options from the list (step 1036). After the message is contracted, the user may view the contracted message on client device interface 230 (step 1037).

In one embodiment, users may create new contractions or expansions by selecting characters from the message and defining their translation.

In another embodiment, a message sent may include hidden messages. When the hidden message is received at second client device 150, it contains a link to the hidden message. The link may be displayed as, for exemplary purposes only and without limitation, an underlined word or set of characters, the characters may have a highlight wherein the background behind the characters is different than the background behind other characters, or the characters may be a different font and/or color. When the hidden message is selected at second client device 150, the hidden message will be displayed. The hidden message may be displayed by, for exemplary purposes only and without limitation, showing an additional message below the original message and/or expanding within the original message. Further, it is contemplated herein that the hidden message may be, but is not limited to, text, images, contact information, location, icons, symbols, artwork, and/or a combination thereof. The hidden message may uncovered by selecting it with a tap, or the hidden message may be only uncovered by a swiping motion.

Additionally, it is contemplated herein that the message, containing text, images, or any content, may be expanded to the entire screen of the device it is being viewed on. It is also contemplated herein that the user that composes the message may configure scrolling settings. The scrolling settings may include, for exemplary purposes only, a predetermined scroll speed and/or desired scroll speed. Alternatively, the receiving user may set a scroll speed for the message.

It is further contemplated herein that a message may be configured with a limited accessibility property that informs how long the message is available to be viewed and/or retrieved. For exemplary purposes only, the sending user may configure a message to only be viewable for five seconds. In another example, the message may be configured to be deleted from the senders phone after 60 minutes, from the recipients phone 30 minutes after it is received, and from the recipient's phone 2 seconds after it is viewed, wherein each time is configurable and adjustable. It is further contemplated herein that a user may perform a single tap on content, such as in a message, to define the underlying meaning of the content, for all of the same or similar content in the message.

In one embodiment, when a message is sent, interface engine 210 communicates with external systems to send the message, such as a cell-phone carrier or a proprietary internet communications infra-structure. The message may be sent by a first user utilizing a first client computing device to a second user utilizing a second client computing device (best shown in FIG. 1A).

In one embodiment, a lite module 190 provides users with basic functionality, and a full module 191 provides users with expanded functionality. In this embodiment, basic functionality includes the ability to compose messages that may be contracted or expanded based on communications with live dictionary 250L, and an interface engine communicate the messages. However, live dictionary 250L utilized by lite module 190 is restricted to a standard dictionary 250, which may include commonly used expansions and contractions. Thus, for exemplary purposes only, a user utilizing lite module 190 would have translation engine 202 that will effectively translate between “cul8r” and “see you later”, but it may not be able to translate between “SP” and “Sanjay Patel”. Further, in this embodiment, users of lite module 190 may not be able to define their own symbols.

In one embodiment, users of full module 191 may have access to a user-defined dictionary that is populated by their personal entries, as well as access to add-on dictionaries. The add-on dictionaries 250 may include a field dictionary that includes field specific symbols such as, in an attorney field dictionary, “POA” may be associated with “Power of Attorney.” These field dictionaries may exist and be loaded for fields such as, for exemplary purposes only and without limitation, the military field, the IT field, and the medical field. Further, the add-on dictionaries may include a contacts dictionary that allows translations for the user's contacts (e.g., if the user has “Sanjay Patel” saved as a contact, the add-on contact dictionary may empower translation engine 202 to expand/contract between “SP” and “Sanjay Patel”).

In use, analysis engine 320 also normalizes dictionary 250. This may include identifying symbols that are users may wish to start using. For example, Y13 as shorthand for “2013” may be commonly used, at which point analysis engine 320 may self-identify this correlation and store it within dictionary.

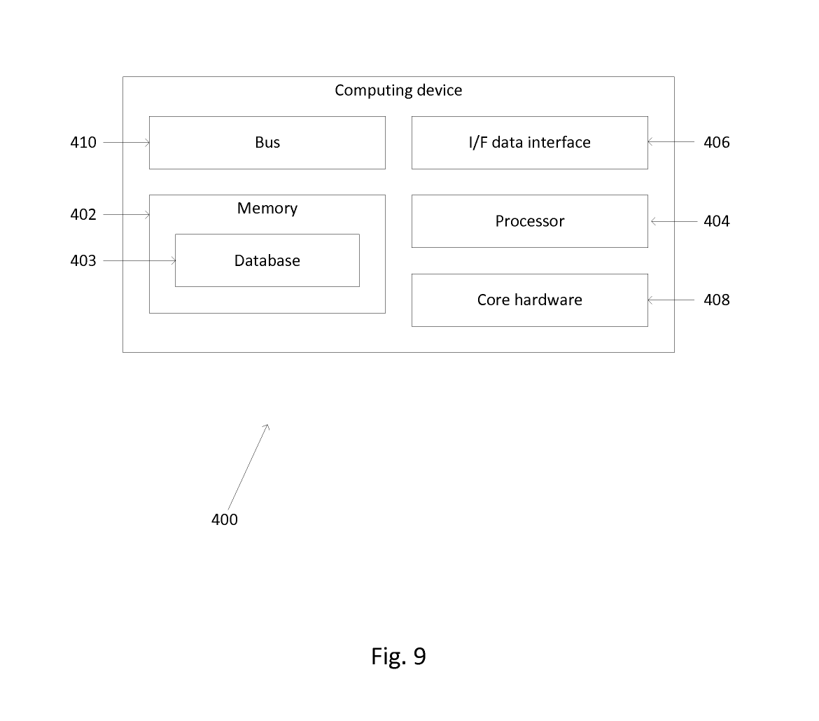

Turning now to FIG. 9, illustrated therein is an exemplary embodiment of computing device 400 that preferably includes bus 410, over which intra-device communications preferably travel, processor 404, interface data device 406, core hardware 408, and memory 402, which preferably includes RAM and hard drive 403.

Date interface 406 may include the mechanical, electrical, and signaling circuitry for communicating data over network 50. Interface 406 may be configured to transmit and/or receive data using a variety of different communication protocols and various network connections, e.g., wireless and wired/physical connections. However, it should be noted that the view used herein is merely for illustration. Interface 406 can further include an input device, such as a card reader, RFID reader, keyboard, a touch screen or a speech recognition subsystem, which enables a user (e.g., a candidate) to communicate information and command selections to processor 404. Interface 406 can also include an output device such as a display screen, a speaker, a printer, etc. Interface 406 can further include an input device such as a touch screen, a mouse, track-ball, or joy stick, which allows the user to manipulate the display for communicating additional information and command selections to processor 204. Through utilization of interface 406, devices 150 and server module 300 are capable of being coupled together, coupled to peripheral devices, and/or input/output devices.

Core hardware 408 comprises the physical hardware necessary to produce a core user experience at devices 150. For instance, core hardware 408 comprises the hardware that supports the smart phone functionality (e.g. camera, touch screen, speakers) if device 150 is a smart phone. Core hardware 408 would comprise server hardware in the case of server module 300 being a server.

First and second devices 150 preferably include computing device 400, and the components thereof. For example, in FIG. 1, first and second devices 150 preferably is a smart phone, such as an iPhone®, that preferably includes most, if not all, of the components of computing device 400. However, it is contemplated herein that first and second devices 150 may be any computing device 400 such as, for exemplary purposes only, a tablet, laptop, or desktop. Also in FIG. 1, server module 300 preferably is a computer such as a tablet, laptop, or desktop that also preferably includes most, if not all, of the components of computing device 400.

The term “module”/“engine” is used herein to denote a functional operation that may be embodied either as a stand-alone component or as an integrated configuration of a plurality of subordinate components. Thus, lite module 190, full module 191, client management module 200, translation engine 202, data and abstraction management engine 204, interface engine 210, creation engine 216 and server module 300 may be implemented as a single module or as a plurality of modules that operate in cooperation with one another. Moreover, although lite module 190, full module 191, client management module 200, translation engine 202, data and abstraction management engine 204, interface engine 210, creation engine 216 and server module 300 are described herein as being implemented as software, they could be implemented in any of hardware (e.g. electronic circuitry), firmware, software, or a combination thereof.

Memory 402 is a computer-readable medium encoded with a computer program. Memory 402 stores data and instructions that are readable and executable by processor 404 for controlling the operation of processor 404. Memory 402 may be implemented in random access memory (RAM), a non-transitory computer readable medium that includes instructions, volatile or non-volatile memory, solid state storage devices, magnetic devices, hard drive, a read only memory (ROM), or a combination thereof.

Processor 404 is an electronic device configured of logic circuitry that responds to and executes instructions. Processor 404 outputs results of an execution of the methods described herein. Alternatively, processor 404 could direct the output to a remote device (not shown) via network 50.

It is to be further appreciated that network 50 depicted in FIG. 1 can include a local area network (LAN) and a wide area network (WAN), other networks such as a personal area network (PAN), or any combination thereof. Further, network 50 in FIG. 1 may include the exact same network configurations, completely different network configurations, or any combination thereof. Such networking environments are commonplace in offices, enterprise-wide computer networks, intranets, and the Internet. For instance, when used in a LAN networking environment, the system 100 is connected to the LAN through a network interface or adapter (not shown). When used in a WAN networking environment, the computing system environment typically includes a modem or other means for establishing communications over the WAN, such as the Internet. The modem, which may be internal or external, may be connected to a system bus via a user input interface, or via another appropriate mechanism. In a networked environment, program modules depicted relative to the system 100, or portions thereof, may be stored in a remote memory storage device such as storage medium. It is to be appreciated that the illustrated network connections of FIG. 1 are exemplary and other means of establishing a communications link between multiple computers may be used.

It should be understood that computing devices 150, 400 and server module 300 each generally include at least one processor, at least one interface, and at least one memory device coupled via buses. Computing devices 150, 400 and server module 300 may be capable of being coupled together, coupled to peripheral devices, and input/output devices. Computing devices 150, 400 and server module 300 are represented in the drawings as standalone devices, but are not limited to such. Each can be coupled to other devices in a distributed processing environment.

In one embodiment, a method of using the system includes a first user initiating a first message on a first computing device. A server increments the first user's reward points when the first message is sent, the first user's reward points being stored in a database on a server, and further identifies, for the first user, a benefit available to the first user in exchange for at least some of the first user's reward points, the benefit relating to the first user receiving a good or service from a retailer.

The programming, in one embodiment on the client device, also accesses, via a translation engine, a dictionary, identifies, via the translation engine, a first string of character in the first message, compares the first string of characters to at least one set of associated entries in the dictionary, wherein each set comprises a first entry and a second entry, translates, via the translation engine utilizing the first computing device's processor and accessing the dictionary, the first message into a first translated message, receives, at a second user's second computing device, the first translated message, and communicates, via the second user's computing device, the first translated message to a second user.

The method also includes incrementing the first user's reward points when the first user performs at least one of the following activities: view a message, register a client management module (e.g., application for a smart phone) that executes on a computing device, expand or contract a message, send a single message to multiple recipients, send a number of messages in excess of a predetermined threshold (e.g., 100 messages in one month, 500 total messages), inviting friends to install the client management module, and post mentions of the system on a social media (e.g., Facebook®).

When practicing this method, the step of translating may include translating between different languages, and the dictionary includes sets of associated entries that are related to at least one of: a profession (e.g, attorneys, doctors), a geographical area (e.g., city, state, county), and a group of people that share at least one characteristic (e.g., students), and the first translated message may include content selected from the group of audio, video, a picture, emoticons, and a hidden message. When practicing this method, the step of translating may include the first user instructing the first computing device to expand or contract the first message, and the software performs that action. If the expansion or contraction was an expansion, the first message may include a first string of characters, and the first string of characters may represent a person's initials.

The benefit may include the first user receiving the good or service for a discounted price, including for free.

The translated first message may include Morse code, in which case the method may further include the second computing device operated by the second user communicating the translated first message, the communication including at least one of the following: flashing the screen consistent with a Morse code representation of the first translated message, and emitting a sound consistent with a Morse code representation of the first translated message.

The method may further include receiving, at the server from the first user's first computing device, a set comprising (1) a string of characters, and (2) a translation option, wherein the set was defined either explicitly or implicitly, storing the set in the database on the server, and incrementing the first user's reward points in the database when the set is received.

And the method additionally include detecting, on the first user's first computing device, a selection of the first string of characters, with the first message including at least the selected first string of characters, displaying, on the first user's first computing device, a list of translation options for the selected first string of characters, and detecting, on the first user's first computing device, a selection of one translation option from the list of translation options.

The first string of characters may include a first number of characters, and the translation option may include a second number of characters, and the first number is less than the second number.

The method may further include scrolling the first translated message on a display of the second computing device, the scrolling comprising a speed that was configured by the first user, and the scrolling may be amended or cancelled by the second user.

In another embodiment, the system includes a non-transitory computer readable storage medium and a computer program embedded therein, the computer program having instructions, which when executed by the computer system cause the computer system to receive a first message from a first user's first computing device, send a translated message to a second user's second computing device, the translated message relating to the first message, increment the first user's reward points when the first message is received, the first user's reward points being stored in a database on a server, and identify, for the first user, a benefit available to the first user in exchange for at least some of the first user's reward points, the benefit relating to the first user receiving a good or service from a retailer. The instructions may further cause the processor to increment the first user's reward points when the first user expands or contracts a message.

The instructions may further cause the processor to translate the first message into the translated message via relying on a dictionary in the server's database, the dictionary having at least one set of associated entries that are related to at least one of: a profession, a geographical area, and a group of people that share at least one characteristic, and the translated message includes content selected from the group of audio, video, a picture, emoticons, and a hidden message. The instructions may also cause the processor to increment the first user's reward points when the first user performs at least one of the following activities: view a message, register a client management module that executes on the first computing device, expand or contract a message, send a single message to multiple recipients, send a number of messages in excess of a predetermined threshold, invite friends to use install the client management module, and post mentions of the system on a social media.

Additionally, the instructions may cause the processor to detect a selection of the first string of characters, the first message having at least the first string of characters, display a list of translation options for the selected first string of characters, and detect a selection of one translation option from the list of translation options, the translated message having at least the selected translation option, and send a set, to a server, including the selected first string of characters and the selected translation option. The first translated message may have content selected from the group of: video and a hidden message. The instructions may also cause the processor to receive a set including at least (1) a string of characters, and (2) a translation option, store the set in the database on the server, and increment the first user's reward points in the database when the set is received.

Further, in one embodiment, the system may translate a recipient identification, such as, for example, expanding initials into an identification of a person and/or that person's contact information (e.g., cellular phone number).

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

Although the systems and methods of the subject invention have been described with respect to the embodiments disclosed above, those skilled in the art will readily appreciate that changes and modifications may be made thereto without departing from the spirit and scope of the subject invention as defined by the appended claims.

What is claimed is:

1. A computer implemented method for correlating enhanced communications with commercial applications, the method comprising:
a first user initiating a first message on a first computing device with memory, a processor and a display;
incrementing the first user's reward points when the first message is sent, the first user's reward points being stored in a database on a server; and
identifying, for the first user, a benefit available to the first user in exchange for at least some of the first user's reward points, the benefit relating to the first user receiving a good or service from a retailer.

2. The computer implemented method of claim 1, the method further comprising:
accessing, via a translation engine, a dictionary;
identifying, via the translation engine, a first string of character in the first message;
comparing the first string of characters to at least one set of associated entries in the dictionary, wherein each set comprises a first entry and a second entry;
translating, via the translation engine utilizing the first computing device's processor and accessing the dictionary, the first message into a first translated message;
receiving, at a second user's second computing device, the first translated message; and
communicating, via the second user's computing device, the first translated message to a second user.

3. The computer implemented method of claim 2, further comprising:
incrementing the first user's reward points when the first user performs at least one of the following activities: view a message, register a client management module that executes on a computing device, expand or contract a message, send a single message to multiple recipients, send a number of messages in excess of a predetermined threshold, inviting friends to install the client management module, and post mentions of the system on a social media.

4. The computer implemented method of claim 2, wherein the step of translating comprises translating between different languages, and wherein the dictionary comprises sets of associated entries that are related to at least one of: a profession, a geographical area, and a group of people that share at least one characteristic, and wherein the first translated message comprises content selected from the group of audio, video, a picture, emoticons, and a hidden message.

5. The computer implemented method of claim 2, wherein the step of translating comprises the first user instructing the first computing device to expand or contract the first message, the method further comprising:
the first computing device expanding or contracting the first message.

6. The computer implemented method of claim 5, wherein the expansion or contraction was an expansion, and wherein the first message includes a first string of characters, and wherein the first string of characters represent a person's initials.

7. The computer implemented method of claim 2, wherein the benefit comprises the first user receiving the good or service for a discounted price.

8. The computer implemented method of claim 2, wherein the translated first message includes Morse code, the method further comprising:
the second computing device operated by the second user communicating the translated first message, wherein communicating includes at least one of the following:
flashing the screen consistent with a Morse code representation of the first translated message, and emitting a sound consistent with a Morse code representation of the first translated message.

9. The computer implemented method of claim 2, further comprising:
receiving, at the server from the first user's first computing device, a set comprising (1) a string of characters, and (2) a translation option, wherein the set was defined either explicitly or implicitly;
storing the set in the database on the server; and
incrementing the first user's reward points in the database when the set is received.

10. The computer implemented method of claim 9 further comprising:
detecting, on the first user's first computing device, a selection of the first string of characters, wherein the first message includes at least the selected first string of characters;
displaying, on the first user's first computing device, a list of translation options for the selected first string of characters; and
detecting, on the first user's first computing device, a selection of one translation option from the list of translation options.

11. The computer implemented method of claim 9, wherein the first string of characters comprises a first number of characters, and wherein the translation option comprises a second number of characters, and wherein the first number is less than the second number.

12. The computer implemented method of claim 9, further comprising:
scrolling the first translated message on a display of the second computing device, the scrolling comprising a speed that was configured by the first user.

13. A non-transitory computer readable storage medium and a computer program embedded therein, the computer program comprising instructions, which when executed by the computer system cause the computer system to:
receive a first message from a first user's first computing device;
send a translated message to a second user's second computing device, wherein the translated message is related to the first message;
increment the first user's reward points when the first message is received, the first user's reward points being stored in a database on a server; and
identify, for the first user, a benefit available to the first user in exchange for at least some of the first user's reward points, the benefit relating to the first user receiving a good or service from a retailer.

14. The non-transitory computer readable storage medium of claim 13, the instructions further causing the processor to:
increment the first user's reward points when the first user expands or contracts a message.

15. The non-transitory computer readable storage medium of claim 13, the instructions further causing the processor to:
translate the first message into the translated message via relying on a dictionary in the server's database, wherein the dictionary comprises sets of associated entries that are related to at least one of: a profession, a geographical area, and a group of people that share at least one characteristic, and wherein the translated message comprises content selected from the group of audio, video, a picture, emoticons, and a hidden message; and
increment the first user's reward points when the first user performs at least one of the following activities: view a message, register a client management module that executes on the first computing device, expand or contract a message, send a single message to multiple recipients, send a number of messages in excess of a predetermined threshold, invite friends to use install the client management module, and post mentions of the system on a social media.

16. The non-transitory computer readable storage medium of claim 13, the instructions further causing the processor to:
detect a selection of the first string of characters, wherein the first message includes at least the first string of characters;
display a list of translation options for the selected first string of characters;
detect a selection of one translation option from the list of translation options, wherein the translated message includes at least the selected translation option; and
send a set, to a server, comprising the selected first string of characters and the selected translation option.

17. The non-transitory computer readable storage medium of claim 16, wherein the first translated message comprises content selected from the group of: video and a hidden message.

18. The non-transitory computer readable storage medium of claim 13, the instructions further causing the processor to:
receive a set comprising (1) a string of characters, and (2) a translation option;
store the set in the database on the server; and
increment the first user's reward points in the database when the set is received.

19. A system for correlating enhanced communications with commercial applications comprising:
a first computing device with memory, a processor and a display, the first computing device:
receives a first message that is entered on the first computing device by a first user;
receives a recipient shortened identification;
translates the recipient shortened identification into a recipient expanded identification;
accesses a dictionary stored in the first computing device's memory;
identifies a first string of character in the first message;
compares the first string of characters to at least one set of associated entries in the dictionary, each set having a first entry and a second entry; and
translates the first message into a first translated message;
a server with a processor and a database, the database including the first user's reward points, the server:
identifies a benefit that is available to the first user in exchange for at least some of the first user's reward points, the benefit relating to the first user receiving a good or service from a retailer;
increments the first user's reward points; and
sends the first translated message to a second computing device according to the recipient expanded identification; and
the second computing device that:
receives the first translated message.

20. The system of claim 19, wherein the first translated message comprises content selected from the group of a Blurt, an audio file, video, a picture, a scrolling message, and a hidden message.
